(19) United States
(12) Patent Application Publication
(10) Pub. No.: US 2009/0059414 A1
(43) Pub. Date: Mar. 5, 2009

(54) Hard disk drive with power saving feature

(75) Inventors: Kang Seok Lee, San Jose, CA (US); Brian D. Strom, Cupertino, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/899,496

(22) Filed: Sep. 5, 2007

(51) Int. Cl. G11B 21/02

(52) U.S. Cl. 360/75

(57) ABSTRACT

A hard disk drive with a head, and a disk that is rotated by a spindle motor. The drive includes a controller that operates in a low-speed idle mode where the spindle motor speed is reduced and the head is moved to a contact start-stop zone of the disk. Reducing the speed of the spindle motor, instead of spinning down the disk allows the disk drive to rapidly resume normal operation. Parking the head at a certain area of the disk, instead of a position off disk, allows the drive to more readily re-establish a mode where data can be retrieved or stored.

### BACKGROUND OF THE INVENTION

1. Field of the Invention

The present invention relates to the operation of a hard disk drive in a low-speed power down mode.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

Data is stored on tracks located on the surfaces of the disks. The disks are rotated by a spindle motor. Rotation of the disks allows access to various locations on the tracks. Additionally, the rotating disk create a flow of air. The flow of air interacts with air bearing surfaces of the heads to create air bearings between the heads and the disk surfaces. The air bearings minimize contact between the heads and disks to prevent potential wear and damage of these components.

Disk drives are typically implemented into systems such as a personal computer. There may be times where the computer is on but not being operated. It is desirable to place the computer and disk drive in a power down mode to save power during such non-usage. This is particularly advantageous when the computer is a portable device that operates on batteries.

There have been developed specifications that define the various active and power down modes. For example the ATA specifications define an idle mode were power to the heads is terminated but the voice coil motor still operates. When an external request is received by the disk drive power is provided to the heads so that data can be written or read from the disks.

The specification also describes a standby mode where power to the spindle motor is terminated. The advantage of the standby mode over the idle mode is that less power is consumed because the spindle motor is turned off. The idle mode advantageously allows for faster response time because there is no need to wait while the spindle motor powers back up.

There is another mode referred to as low-speed idle wherein the heads are parked on a ramp and the disk speed is reduced. The reduction of disk speed conserves power but allows for a rapid acceleration to full operating speed. The heads are parked on the ramp to avoid contact between the heads and the disks. The disadvantage of this mode is that it requires a certain amount of time to unload the heads off of the ramp. This impacts the response time of the disk when in the low-speed idle mode. Another disadvantage of this mode is that it requires a load/unload system. Load/unload systems require a ramp, a larger voice coil motor, and associated circuitry, that increases the complexity and cost of the disk drive.

### BRIEF SUMMARY OF THE INVENTION

A hard disk drive with a head, and a disk that has a contact start-stop zone. The disk is rotated by a spindle motor. The drive further has a controller that operates in a low-speed idle mode where the spindle motor speed is reduced and the head is moved to the contact start-stop zone of the disk.

### BRIEF DESCRIPTION OF THE DRAWINGS

FIG. 1 is a top view of an embodiment of a hard disk drive;

FIG. 2 is a schematic of an electrical circuit for the hard disk drive;

FIG. 3 is a flowchart showing a low-speed idle mode of the disk drive.

### DETAILED DESCRIPTION

Disclosed is a hard disk drive with a head, and a disk that is rotated by a spindle motor. The drive includes a controller that operates in a low-speed idle mode where the spindle motor speed is reduced and the head is moved to a contact start-stop zone of the disk. Reducing the speed of the spindle motor, instead of spinning down the disk allows the disk drive to rapidly resume normal operation. Parking the head at a certain area of the disk, instead of a position off disk, allows the drive to more readily re-establish a mode where data can be retrieved or stored. Additionally, this approach allows the drive to enter a low speed idle mode without the relatively complex mechanisms that are required to off-load the head.

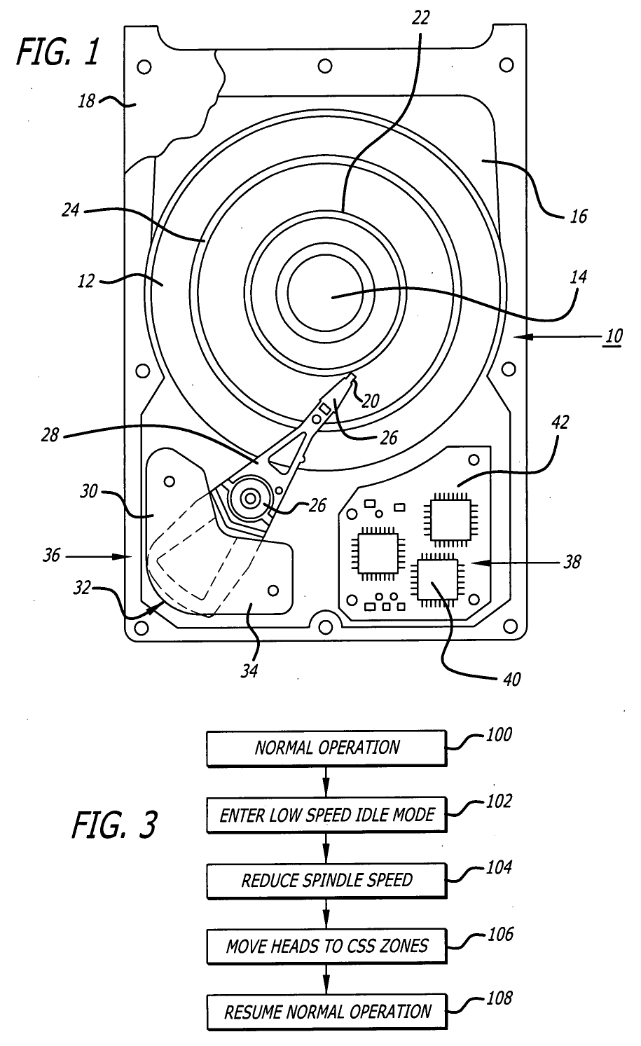

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown). The write element (not shown) magnetizes the disk 12 to write data. The read element (not shown) senses the magnetic fields of the disks 12 to read data. By way of example, the read element may be constructed from a magneto-resistive material that has a resistance which varies linearly with changes in magnetic flux. The write element can magnetize the disk in a vertical direction. Vertical magnetization is commonly referred to as perpendicular recording.

Each disk surface may have a contact start-stop (“CSS”) zone 22. The CSS zone 22 may be an area of the disk that does not contain data. The CSS zone 22 may have a textured surface or a smooth surface. Each disk surface may also have a middle diameter CCS zone 24. The middle diameter zone 24 may include data.

Each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

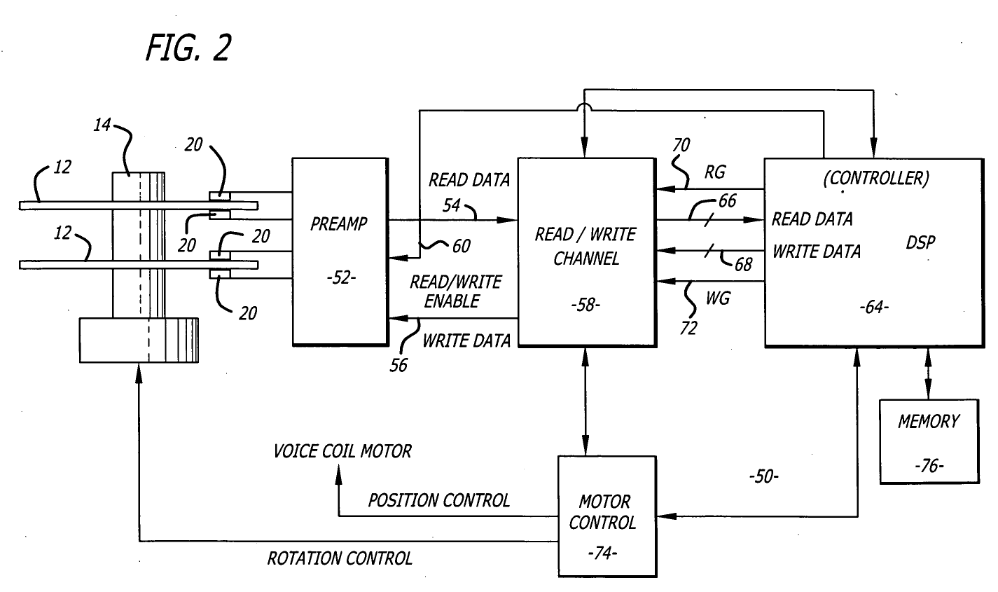

FIG. 2 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 62 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 62 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the instructions to operate the controller and disk drive. Alternatively, the controller 64 may have embedded firmware to operate the drive. The controller 64 may operate in various modes including a low-speed idle mode. During this mode the controller 64 may provide signals to various components of the drive such as the spindle motor and the voice coil motor.

FIG. 3 is a flowchart showing the disk drive operating in a low-speed spindle mode. In step 100 the disk drive is in a normal operation mode. Alternatively, the drive may be in some other mode such as standby or idle. In step 102 the drive enters the low-speed idle mode. The drive may receive instructions by an external device to enter the low-speed idle mode. Alternatively, the disk drive may automatically enter the low-speed idle mode if it has not received any external request within a predetermine time interval.

In step 104 the spindle motor speed is reduced. By way of example, the spindle motor speed may be reduced from a normal operating speed of 7200 rpm to a speed of 5400 rpm. At a speed of 5400 rpm the rotating disk may still generate a sufficient air flow so that the heads do not make contact with the disk. In step 106 the head is moved to the CSS zone of the disk surfaces. The CSS zone does not have data so that if the head makes contact with the disk during the low-speed idle mode no data will be lost.

In step 108 the disk drive enters another mode such as normal operation. If placed in normal operation the spindle speed is accelerated and the heads are moved back over the data portions of the disk.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, during the low-speed idle mode the heads may be moved to the middle diameter CSS zone 24 of the disk. At this position the bias of the voice coil motor is at a minimum so that minimal energy is required to maintain the position of the heads. Additionally, at this position of the disk the air bearing height is generally at a maximum so that an air bearing separates the heads and disk even at a reduced spindle motor speed.

What is claimed is:

1. A hard disk drive, comprising:
a disk that has a contact start-stop zone;
a spindle motor that rotates said disk;
a head coupled to said disk;
an actuator arm assembly coupled to said head; and,
a controller coupled to said spindle motor and said actuator arm assembly, said controller operates in a low-speed idle mode that reduces a speed of said spindle motor and causes said head to be adjacent to said contact start-stop zone when in said low-speed idle mode.

2. The disk drive of claim 1, wherein said contact start-stop zone does not contain data.

3. The disk drive of claim 1, wherein said contact start-stop zone is at a middle diameter of said disk.

4. The disk drive of claim 1, wherein said speed of said spindle motor is reduced to a value that does not create a significant variation in a flying height of said head.

5. The disk drive of claim 4, wherein said spindle motor speed is reduced from approximately 7200 rpm to approximately 5400 rpm.

6. The disk drive of claim 1, wherein said contact start-stop zone has a smooth surface.

7. A hard disk drive, comprising:
a disk that has a contact start-stop zone;
a spindle motor that rotates said disk;
a head coupled to said disk;
an actuator arm assembly coupled to said head; and,
controller means for operating in a low-speed idle mode that reduces a speed of said spindle motor and causes said head to be adjacent to said contact start-stop zone when in said low-speed idle mode.

8. The disk drive of claim 7, wherein said contact start-stop zone does not contain data.

9. The disk drive of claim 7, wherein said contact start-stop zone is at a middle diameter of said disk.

10. The disk drive of claim 7, wherein said speed of said spindle motor is reduced to a value that does not create a significant variation in a flying height of said head.

11. The disk drive of claim 10, wherein said spindle motor speed is reduced from approximately 7200 rpm to approximately 5400 rpm.

12. The disk drive of claim 7, wherein said contact start-stop zone has a smooth surface.

13. A method for operating a hard disk drive in a low-speed idle mode, comprising:
reducing a speed of a spindle motor that rotates a disk; and,
moving a head to a contact start-stop zone of the disk.

14. The method of claim 13, wherein the contact start-stop zone does not contain data.

15. The method of claim 13, wherein the contact start-stop zone is at a middle diameter of the disk.

16. The method of claim 13, wherein the speed of the spindle motor is reduced to a value that does not create a significant variation in a flying height of the head.

17. The method of claim 16, wherein the spindle motor speed is reduced from approximately 7200 rpm to approximately 5400 rpm.

18. The method of claim 13, wherein the contact start-stop zone has a smooth surface.
